(19) United States
(12) Patent Application Publication
(10) Pub. No.: US 2004/0236608 A1
(43) Pub. Date: Nov. 25, 2004

(54) Medical and dental software program

(76) Inventors: David Ruggio, Arlington Heights, IL (US); Matthew Ruggio, Arlington Heights, IL (US)

Correspondence Address: Barnes & Thornburg, P.O. Box 2786, Chicago, IL, 60690-2786, US

(21) Appl. No.: 10/851,285

(22) Filed: May 21, 2004

Related U.S. Application Data
(60) Provisional application No. 60/472,455, filed on May 21, 2003.

(51) Int. Cl. G06F 17/60

(52) U.S. Cl. 705/2; 705/3

(57) ABSTRACT

A medical and dental software program that generates computerized data reports and patient progress notes based upon information gathered from testing and from patients' personal and medical information. The medical and dental software program generates reports based upon information gather from diagnostic testing systems currently in use, inclusive of, but not limited to visual, physical, radiographic, laser, pulp testing, microscopic, biopsy, CT scan, MRI, electron beam and blood analysis. The medical and dental software program is designed to integrate future diagnostic systems (in the form of modules) that are under development or in current use in specialty fields of medicine. The program compiles the reports and integrates them into a computerized patient progress note, which is the document format that is used in the medical and dental professions. The program utilizes human anatomic forms (anatomic fields and anatomic grids) that represent a particular organ or body part—i.e. the mouth, the oral/facial complex, the brain, heart, lung, kidney and alike to aid in the input of patient data. The anatomic forms are used by the practitioner to enable them to easily enter relevant medical diagnostic data into the system. Each grid and/or field contains a series of subparts that allow the practitioner to enter specific detail with regards to a particular organ or body part. The findings such as normal, a variation of normal and pathologic are subparts a practitioner would find upon examination or interpretation of a particular organ or body part. From those findings entered into the program, the practitioner can form a diagnosis, treatment plan, document the treatment and subsequently generate a report.

This application claims priority from U.S. Provisional Patent Application Serial No. 60/472,455, which was filed on May 21, 2003.

### BACKGROUND OF THE INVENTION

A patient's medical or dental written record is a complex collection of all relevant “facts” relating to the patient's personal, medical and dental information, which is utilized in order to provide proper diagnosis and treatment. Collecting and recording the data is required to properly create the record. This raw data can be quite voluminous, and has led to efforts in the medical and dental professions to manage patient data with a computer rather than in hand written form. Present computer aided patient record keeping systems have not simplified the steps necessary to enable the practitioner to quickly and accurately generate a complete written record of a patient in a relatively short duration. These systems further do not provide much assistance to aid the practitioner in formatting proper progress, diagnosis and treatment notes.

### SUMMARY OF THE INVENTION

The present invention provides for a medical and dental software program that generates computerized data reports and patient progress notes based upon information gathered from patients in the form of chief complaints, diagnostic testing performed by the practitioner, from procedures performed and from patients personal and medical information and also practitioner charting and procedure note writing. The medical and dental software program generates reports based upon information gathered from diagnostic testing systems currently in use, inclusive of, but not limited to visual, physical, radiographic, laser, electric pulp testing, microscopic, biopsy, CT scan, MRI, electron beam and blood analysis. The medical and dental software program is designed to integrate future diagnostic systems (in the form of modules) that are under development or in current use in specialty fields of medicine. The program compiles the reports and integrates them into a computerized patient chart that includes progress notes as well as inputted patient and practitioner data. The data is compiled in a document format that is used in the medical and dental professions. The program utilizes human anatomic forms (anatomic grids and anatomic fields) that represent a particular organ or body part—i.e. the mouth, the oral/facial complex, the brain, heart, lung, kidney and alike to aid in the input of patient data. The anatomic forms are used by the practitioner to enable them to easily enter relevant medical diagnostic data into the system. Each grid contains a series of anatomic subparts that allow the practitioner to enter and select multi-tiered templated information (with specific detail) with regards to a particular organ or body part. The findings such as normal, a variation of normal and pathologic are information that a practitioner would find upon examination or interpretation of diagnostic tests (e.g.: radiographs, MRI, CT Scan, etc.) of a particular organ or anatomical structure. From subjective information elicited from a patient and the findings from an examination and diagnostic test, the practitioner can enter those findings into the program, which permits the formation of a diagnosis, treatment plan, document the treatment and subsequently generate a report.

### BRIEF DESCRIPTION OF THE DRAWINGS

FIG. 1 is a flow diagram displaying an overview of the medical and dental software program.

FIG. 2 is a flow diagram based on the flow diagram of FIG. 1 displaying an overview of the patient report for specific modules.

FIG. 3 is a flow diagram based on the flow diagram of FIG. 1 displaying an overview of the visual report.

FIG. 4 is a flow diagram based on the flow diagram of FIG. 1 displaying an overview of the patient report for test modules.

FIG. 5 is an illustration of an anatomical grid data input screen for adding data.

FIG. 6 is an illustration of a patient data screen depicting a report date tree.

FIG. 7 is an illustration of a patient progress note.

### DETAILED DESCRIPTION OF THE INVENTION

For the purpose of promoting an understanding of the principles of the invention, references will be made to the embodiment illustrated in the drawings. Specific language will also be used to describe the same. It will, nevertheless, be understood that no limitation of the scope of the invention is thereby intended, such alterations and further modifications in the illustrated device, and such further applications of the principles of the invention illustrated herein being contemplated as would normally occur to one skilled in the art to which the invention relates. The medical and dental software program 10 is beneficial to the end user in that it has flexibility in its multi-tiered templates, procedures, and anatomic grids. The program includes standard grids that cannot be edited and custom grids that a user can create and edit.

The medical and dental software program 10 allows the practitioner to efficiently record data for a patient for a variety and unlimited number of dental and medical procedures, tests, and observations and then create a series of individual data reports organized chronologically on a date tree 50 for ease of access at a later date. The practitioner, at any time, may open an existing patient chart and access any report on the date tree 50 for that patient by clicking on the entry on the date tree 50, which opens the selected report.

A medical or dental progress note is a written record generated by a physician, dentist, nurse, hygienist or other office, hospital, clinic, outpatient healthcare facility staff member that documents any interaction in the office, hospital, clinic, or outpatient healthcare facility, between the practitioner and patient. Depending upon the type of interaction, the information gathered is categorized and put into the appropriate module and relevant fields. A progress note (in the field of dentistry) is inclusive of subjective reports, objective reports (such as visual, physical, radiograph, pulp testing, periodontal probing or laser reports), assessment and diagnosis reports, treatment plan reports, procedure notes, drug prescriptions, laboratory (lab) prescriptions (among others). A progress note (in the field of medicine) is inclusive of subjective reports, objective reports (such as visual, physical, radiograph, auscultation, ECG, blood analysis, pulmonary function tests, PET scans, MRI, CT scan, ECG, etc. ), assessment and diagnosis reports, treatment plan reports, procedure notes (operative notes), drug prescriptions, lab prescriptions (among others).

One common set of guidelines for Progress Note (PN) writing is the “SOAP” model. In this idealized format, the author documents information relevant to the patient contact including the account of the illness (symptoms) by the patient (Subjective data), observations by the health care provider, such as vital signs and physical exam (Objective data), the formulation of a diagnosis (differential diagnosis, definitive diagnosis, preoperative diagnosis and post-operative diagnosis) (Assessment) and the formulation of a treatment plan (the Plan). This structure of a Progress Note is widely recognized by most health care providers, and is believed in the industry to be an organized, logical, method for documenting, retrieving and evaluating information in the record. Although different general types of notes may be created (patient visit, telephone, advice, consultation, comment, summary) and different providers may input different varieties of data, the base organization into these four areas (SOAP) applies generally across all patient notes.

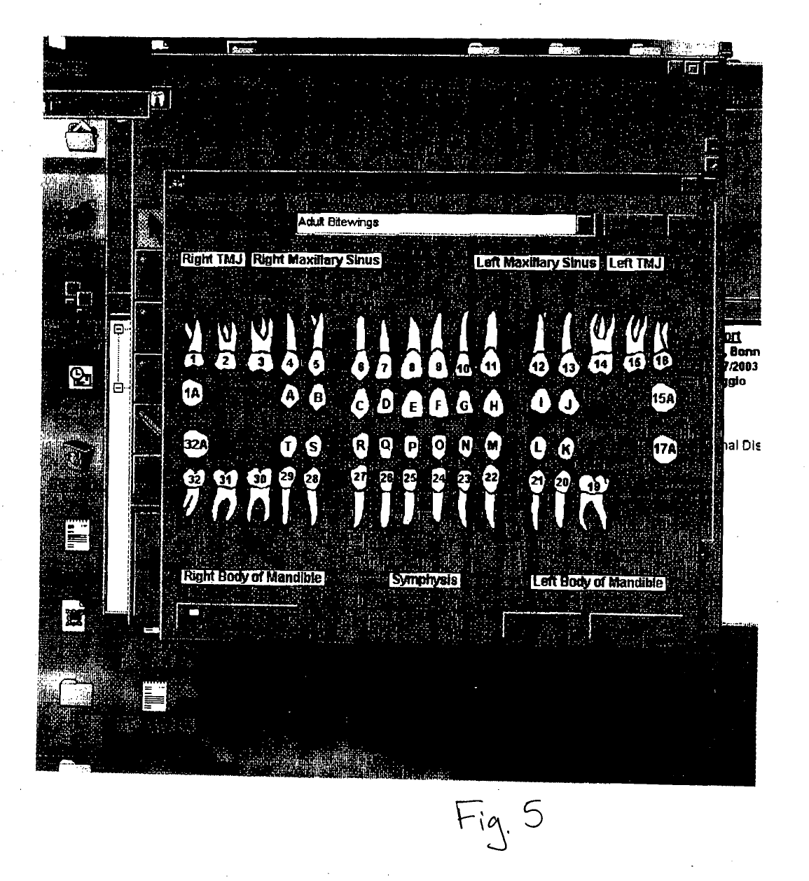

The medical and dental software program 10 of the present invention is designed to generate computerized progress notes based upon information gathered from patients including patient personal and prior medical information. The medical and dental software program further generates reports and progress notes based upon information created by diagnostic systems currently in use, inclusive of, but not limited to visual, physical, radiographic, laser, electric pulp testing, microscopic, biopsy, CT scan, MRI, electron beam and blood analysis. The system is designed to allow for the integration of future diagnostic systems or current diagnostic systems in the form of add on modules that are applicable to a particular specialty within the medical or dental field. The program compiles the findings and integrates them into either individual reports or into a compiled patient progress note, which is in a document format that is used in the medical and dental professions. The program utilizes human anatomic forms (anatomic grid and anatomic fields), as shown in FIG. 5, that represent a particular organ or body part—i.e. the mouth, the oral/facial complex, the brain, heart, lung, kidney among others. The anatomic forms are used by the practitioner to enable them to quickly and easily enter relevant diagnostic data into the system. A dentist's primary function is the diagnosis, treatment planning and care of the oral structures (teeth, gums, lips, tongue, palate, etc.). The anatomic grids and forms for a dentist are formatted to account for all of the aforementioned anatomic structures to dentistry. A cardiologists primary function is the diagnosis, treatment planning and nonsurgical care of the heart and its associated anatomic structures (right atrium, left atrium, right ventricle, left ventricle, mitral valve, tricuspid valve, aortic valve, the electrical system, AV node, SA node the coronary arteries, etc. The anatomic grids and forms for a cardiologist are formatted to account for all of the aforementioned anatomic structures pertinent to cardiology.). Each grid and/or field contains a series of anatomic subparts that allow the practitioner to enter specific detail with regards to a particular organ or anatomic structure that is the primary focus of his/her field of medicine and dentistry. To enter data for a particular anatomic subpart, i.e. molar, for the dentist, or for a left ventricle of the heart for the cardiologist, the practitioner merely maneuvers the computer mouse indicator over the subpart to chart and clicks thereupon. Once the particular anatomic subpart has been selected, data entry choices appear to enable the practitioner to select the data they want to appear for the particular subpart. The findings such as normal, a variation of normal and pathologic are information a practitioner would find upon examination or interpretation of diagnostic tests for that particular organ or body part. From those findings entered into the program, the practitioner can form a diagnosis, treatment plan, document the treatment (procedure) and subsequently generate one or more reports.

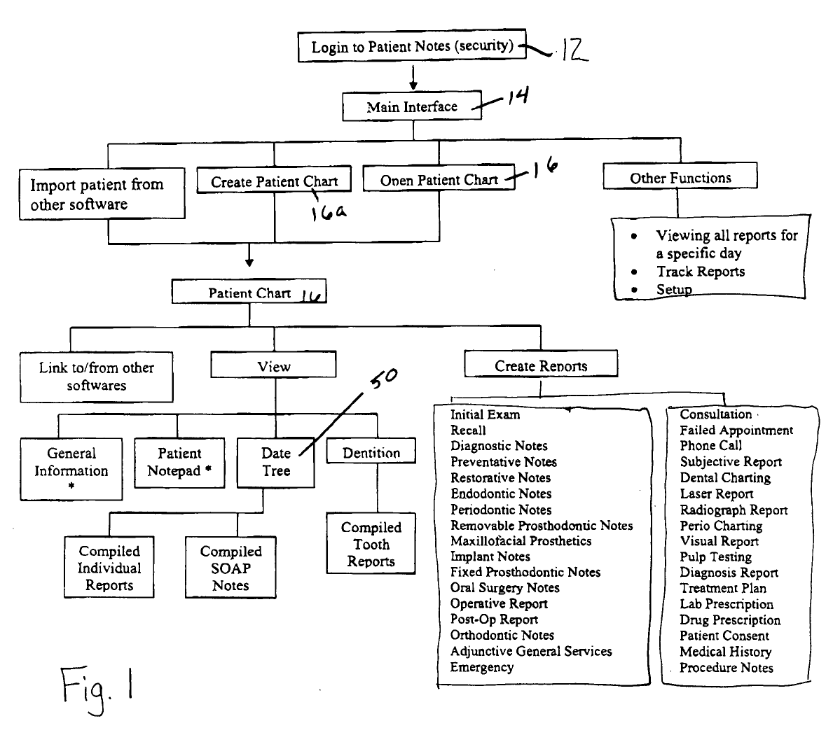

FIG. 1, illustrates an overview of the medical and dental software program 10. The software program 10 is initiated by logging into the software program 10, which requires the entry of a security code. Once the practitioner (user) is logged into the software program 10 and is at the main interface 14, he/she can either open or create a patient chart 16, as well as view all patient reports run on a specific day, run report logs for each type of report (i.e. outstanding treatment reports, lab prescriptions, among others). Other functions from the main interface include authentication of all reports and creating and editing templates. Each patient chart 16 is given its own unique patient identifier code. The identifier code is attached to all data stored by the program 10. Each report will store data in separate databases and mark the data with the patient identifier code. Once a patient chart 16 is created or opened, one or more individualized reports can be created for a particular day by inputting data into existing report modules. Once the data from the report modules are collected they can then be compiled to complete a patient progress note for a given period of time. The report modules (dental version) include a consultation module 18, a subjective report module 20, a laser report module 22, a visual/physical exam report module 24, a periodontal charting module 36, a radiographic report module 26, a pulp testing module 27, a diagnosis report module 28, a treatment plan report module 30, a procedure note module 32, a recall exam module 29, an initial exam module 31, an emergency exam module 33, a drug prescription module 34 and a lab prescription module 38. Other report modules include failed appointment module 76, phone call module 78, patient consent module 80, medical history 82, diagnostic notes module 84, preventative notes module 86, restorative notes 88, endodontic notes 90, peridontal notes 92, removable prosthodontic notes 94, maxillofacial prosthetics 96, implant notes 98, fixed prosthodontic notes 100, oral surgery notes 102, operative report 104, post-op report 106, orthodontic notes 108, adjunctive general services 110, referral to module 112 and a referral from module 114. Each of these modules is accessible by use of an icon or from a toolbar menu and can be used to create a report as shown in FIG. 1. Depending upon the specialty of the practitioner, additional modules can be created and added to accommodate the reporting requirements of the practitioner.

When in the main interface 14, the practitioner may either open an existing patient chart 16, create a new patient chart 16a, as shown in FIG. 1, import information from other programs to create a new patient chart or run other functions. Once the patient chart 16 has been opened access is available to the patient's information, patient's notepad, patient's anatomic history chart and the patient's date tree. The patient chart 16 general information includes the patient's name, address, insurance provider information, reaction to medication, medical alerts, among other relevant information.

There are thirty six indexed reports—consultation, subjective, diagnosis, treatment plan, procedure notes, recall exam, initial exam, emergency exam, drug prescription, laboratory prescription, failed appointment note, phone log report—available for the practitioner to create for the patient for a particular day. Each module within the software program 10 has the ability to create reports and display the reports on the patient's date tree 50. Each of the modules are located on the main menu of the patient's chart in the form of an icon or within the toolbar.

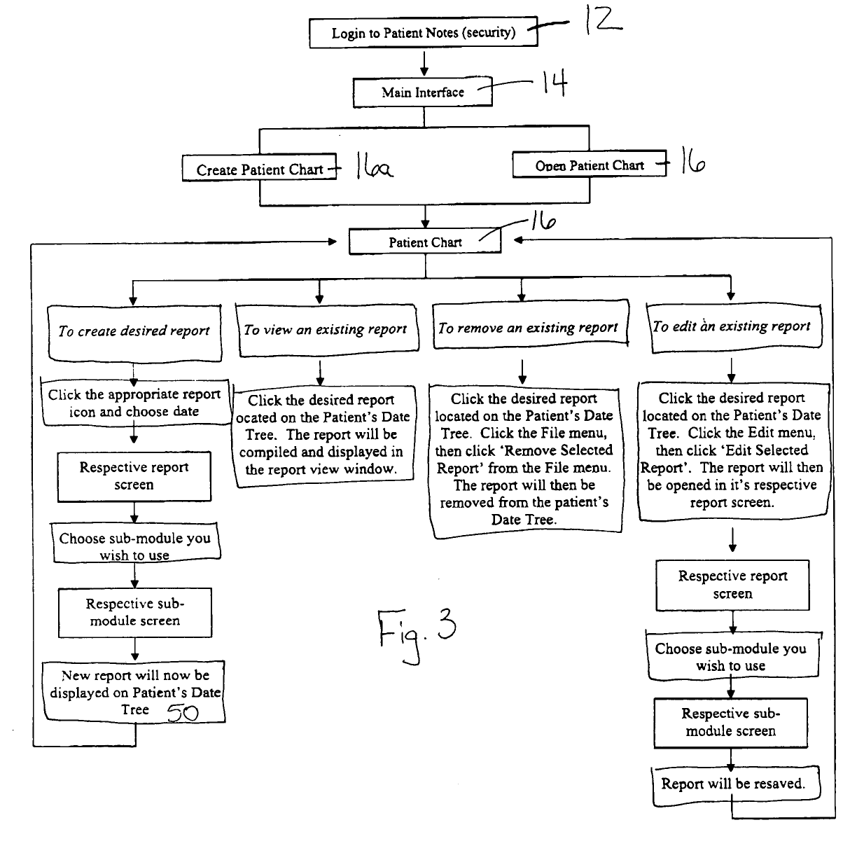

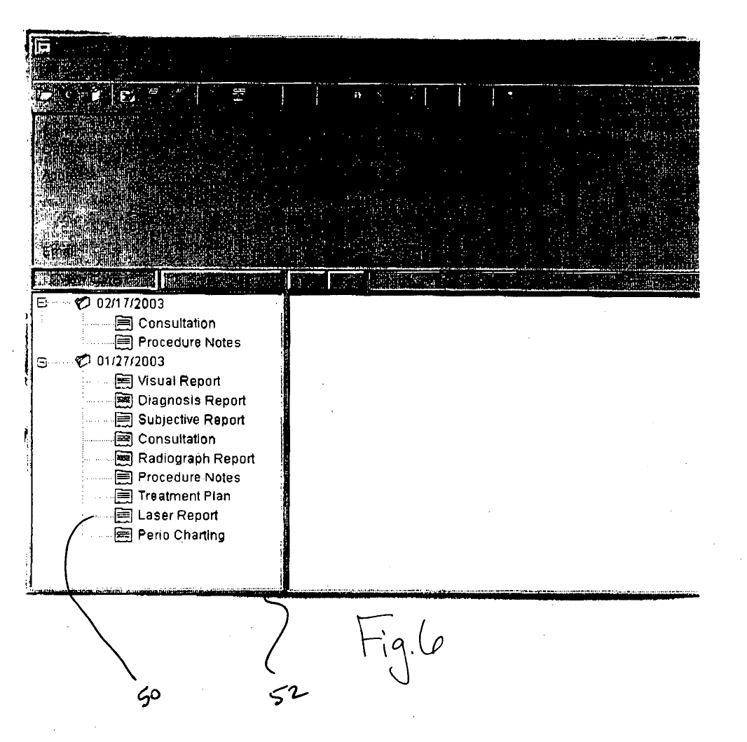

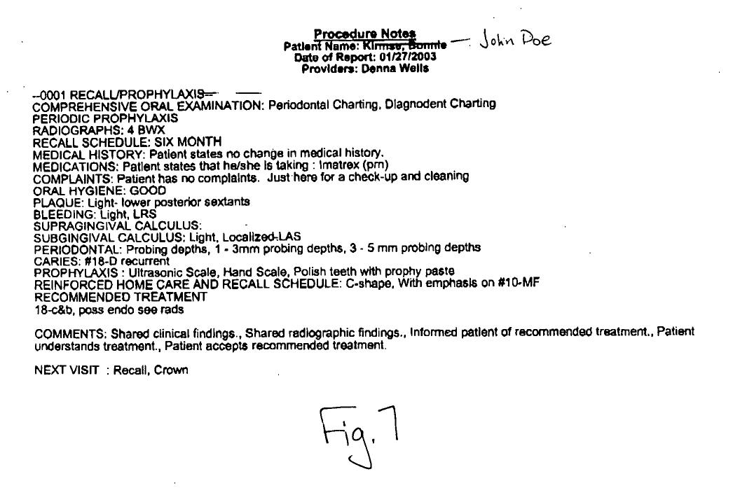

Once a new or existing patient chart 16, 16a is opened or created, the consultation module 18 can be opened to add a new consultation for a given date, as shown in FIG. 3. The consultation module 18 allows the practitioner to chart the patient's concerns such as questions regarding procedure options, patients complaints of pain or other physical observances and a doctor's explanation of the different treatment options, risks, benefits, advantages and disadvantages, etc. The consultation module 18 also allows the practitioner to add individualized notes as desired. The consultation module 18 includes a consultation screen 44 that comprises a multi-tiered template that permits the practitioner to select one or more subject lines. Selecting the subject lines of the primary template prompts the program to open one or more secondary templates, corresponding to the primary template. The secondary templates contain specific subject line information that can be selected by the practitioner. Once the relevant subject lines are selected from the primary and secondary templates, the program compiles the related subject lines from the templates and stores the compiled data in a database. The data is compiled generating a consultation report 46, which is shown on a date tree 50, as shown in FIG. 6, for that particular patient. The date tree 50 of the patient's chart allows the practitioner to visually observe in a date order each report generated for a particular patient. Once the consultation report 46 is compiled it may remain as an individual report accessible from the patient date tree 50 and can be compiled into a SOAP note, as shown in FIG. 7, at the option of the practitioner. The data collected by the consultation module 18 is stored in a consultation database and is identified by patient identification code and a date code.

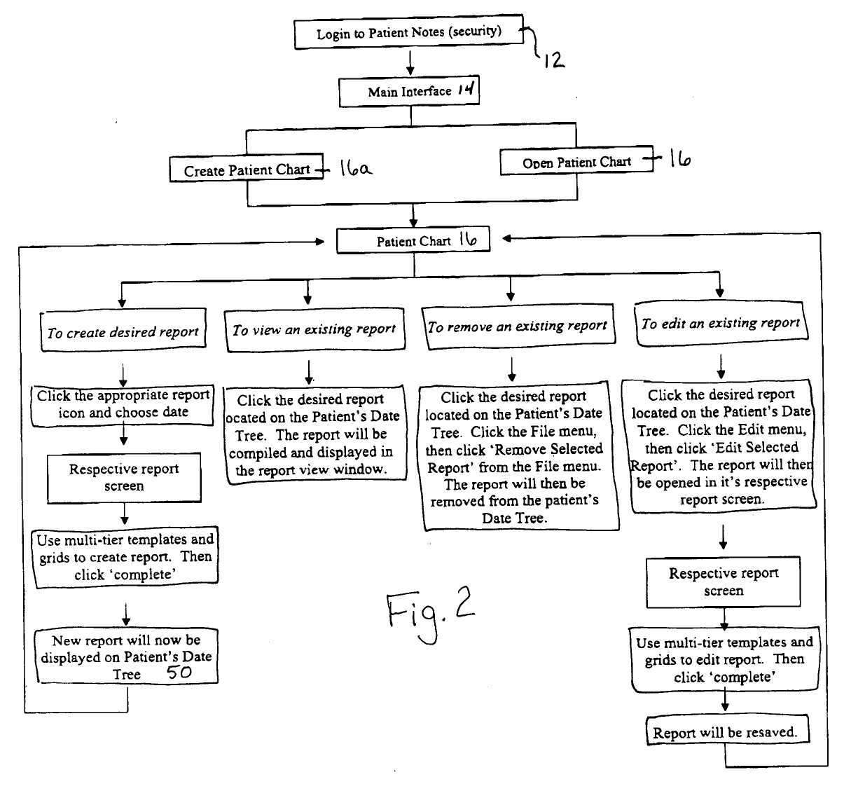

With the patient chart 16 open, the practitioner can select the subjective report module 20, as shown in FIG. 2. The flow chart of FIG. 2 applies to the following modules: consultation, subjective report, diagnosis report, treatment plan, procedure notes, initial exam, recall, diagnostic notes, initial exam, recall diagnostic notes, preventative notes, restorative notes, endodontic notes, periodontic notes, removable prosthodontic notes, maxillofacial prosthetics, implant notes, fixed prosthodontic notes, oral surgery notes, operative reports, post-op reports, orthodontic notes, adjunctive general services and emergency module. The subjective report module consists of grids and multi-tiered templates with sets of patient symptoms and patient complaints. The subjective report module 20 allows the practitioner to record complaints and symptoms of the patients by selecting general and specific subject lines within the primary and secondary templates. In particular to the grids, the subjective module allows the practitioner to use a subjective analysis grid that is question driven to aid the practitioner in eliciting responses from their patient. The information included in the subjective report includes verbal information that a patient relays to the physician, dentist or healthcare provider regarding a chief complaint, a symptom, a set of symptoms or a problem, such as the patient may complain of bleeding gums on the upper left side of their mouth, pain in a tooth, an ill-fitting prosthetic device, etc. The subjective report module 20 describes the symptoms and their location experienced by the patient. The software program comes equipped with multi-tiered templates for each text report. The primary template would include subject lines with general oral regions and the secondary template would include subject lines with specific oral symptoms for the related region. The multi-tiered templates can be added, edited or deleted. Within each module there are anatomic grids that cannot be edited. There are also custom grids that can be edited. The subjective report is compiled into its own text report and is indexed on the date tree 50 for the patient as an individual report or can be compiled into a progress note at the option of the practitioner.

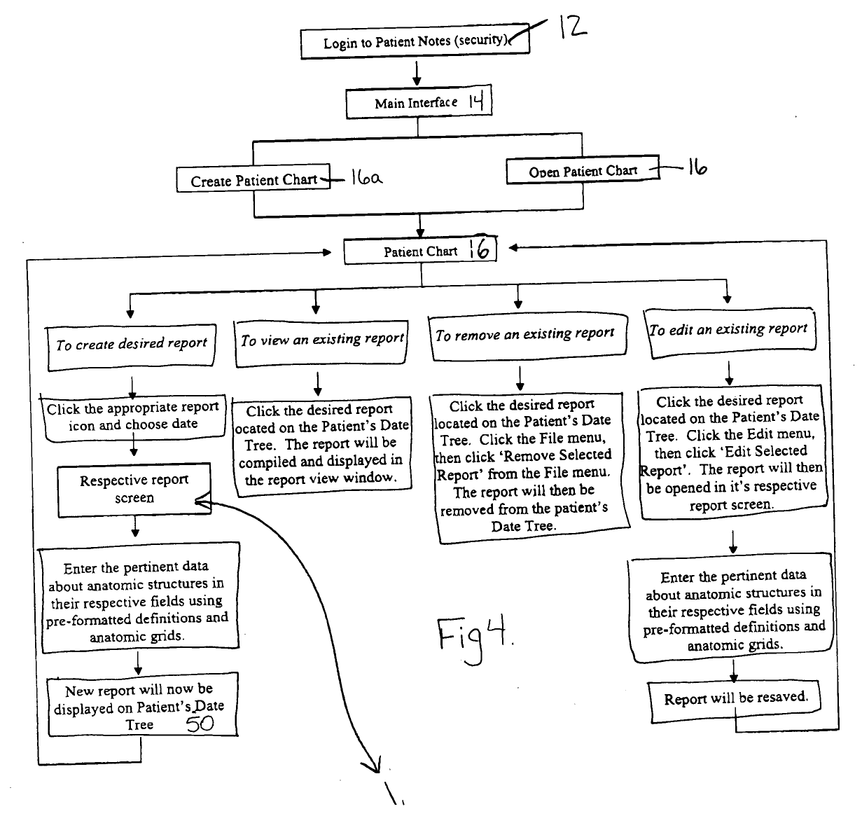

Additionally, the practitioner may utilize the laser report module 22 for an open patient chart 16, as shown in FIG. 4. The flow chart of FIG. 4 applies to the following modules: laser report, dental charting, perio charting, pulp testing and radiographic report. The laser report module 22 includes a database that is comprised of 157 individual sub-fields for each section of the laser report. The laser report module 22 includes a compiler that allows for the fields to be oriented into a report format readable by the practitioner. The laser report module 22 further comprises an anatomic grid interface 48, as shown in FIG. 5 that is a textual representation all of teeth (permanent and primary). This grid is specific to dentistry and other anatomic grids can be used for other medical areas. The anatomic grid interface 48 allows the practitioner to use a computer mouse to click upon a particular anatomic region (tooth), such as a maxillary right permanent first molar or a mandibular left deciduous canine. If the practitioner has conducted a laser report on a particular tooth, for example, a lower right molar, the practitioner would select the desired lower right molar from the anatomic grid interface 48, which opens a series of sub fields (which are the surfaces, i.e.: top, buccal side, lingual side—of a tooth) that are adapted to allow the practitioner to enter data from the findings of the laser exam. The data entered into the series of field for the lower right molar are given patient ID number and stored in laser examination database. Once the data for the desired teeth are entered into the anatomic grid interface 48 by the practitioner, the laser report module 22 of the program compiles the fields to be interpreted into a readable text report. The compiled laser report is then accessible by the practitioner from a date tree 50 of the patient chart 16 of the software program 10.

The radiographic report module 54, which uses the flow arrangements of FIG. 4, is designed to enable the practitioner to record the results of the radiograph examination (interpretation of radiographic images of anatomic structures) relating to detection of dental caries, tooth related pathology, tooth impaction, dental restorations, root periapex and the like. The radiographic report module 54 includes an anatomic radiographic grid 55 that allows the practitioner to visually select the particular teeth for which radiographic data is available for input. The grid consists of anatomic structures that the user would see on an X-ray. The user would select a particular anatomic structure (a tooth, for example) and anatomic fields appear. Each field is a sub anatomic part of the anatomic structure (e.g.: anatomic structure is the tooth, the subparts of the tooth are, the root of the tooth, the crown portion of the tooth, the endodontic space (“the nerve”), etc.) Each field has definitions that are the radiographic findings. (The findings are the statements of existing conditions—normal conditions, variations of normal conditions, restorations (fillings and crowns), prosthetic devices (fixed bridges and partials), anomalies, pre-pathologic conditions and pathologic conditions of a particular anatomic structure. The software program includes definitions for each anatomic structure; however, the user can add, delete or edit the definitions through the programs definition manager. The program 10 also compiles all of the data entered by the practitioner into a readable text report.

The visual/physical exam module 24 shown in the flow chart of FIG. 3 is comprised of several sub-modules that comprise the general visual/physical exam report module 22. The visual sub-report modules include:

1. Teeth report

2. Edentulous report

3. Occlusion report

4. TMJ report

5. Intraoral Soft tissue report

6. Extraoral Soft Tissue report

7. Salivary Gland report

The visual tooth examination report 56, as shown in FIG. 3, allows the practitioner to input visual findings made during the dental visit. The visual tooth inspection report 56 includes an anatomic visual tooth grid 57 that allows the practitioner to select the particular teeth for which visual inspection data is available for input. The visual tooth inspection report 56 includes anatomic fields or anatomic grids 57 that allow the user to select and enter information obtained through examination by selecting definitions within those fields. (The definitions are findings, the statements of existing conditions—normal conditions, variations of normal conditions, restorations (fillings and crowns), prosthetic devices (fixed bridges and partials), anomalies, pre-pathologic conditions and pathologic conditions of a particular anatomic structure. The software program includes definitions for each field (anatomic structure); however, the user can add, delete or edit the definitions through the programs definition manager.)

The next sub-module of the visual report module is the edentulous report submodule (edentulism is a condition where one is missing teeth, one, some or all teeth) has anatomic fields or anatomic grids that allow the user to enter information obtained through examination by selecting definitions within those fields. (The definitions are findings, the statements of existing conditions—normal conditions, variations of normal conditions, prosthetic devices (dentures and partials), anomalies, pre-pathologic conditions and pathologic conditions of a particular anatomic structure. The software program includes definitions for each anatomic structure; however, the user can add, delete or edit the definitions through the programs definition manager.)

The next sub-module of the visual report module is the occlusion report sub-module 60, as shown in FIG. 3. The occlusion report sub-module 60 allows the practitioner to chart the interocclusal arch relationships, jaw position, relationships and skeletal profiles. The software program includes a preformatted occlusion grid with definitions for occlusion analysis; however, the user can add, delete or edit the definitions through the programs definition manager.)

The next sub-module of the visual report module is the TMJ examination report sub-module that has anatomic fields 63 with respect to the temporomandibular joint proper, the musculature that controls movements of the lower jaw and the teeth (and their relationship to the TMJ). The TMJ (temporomandibular joint) report 62, as shown in FIG. 3, is designed to allow the practitioner to report on the jaw and associated muscles, limitations in the ability of the patient to make the normal movements and parafunctional movements of the mandible (lower jaw). The software program includes definitions for each anatomic structure; however, the user can add, delete or edit the definitions through the programs definition manager.

The next sub-module of the visual report module is the soft tissue intraoral examination report sub-module 64, as shown in FIG. 3. The soft tissue intraoral examination report sub-module 64 is designed to allow the practitioner to report on the conditions of the soft tissues of the mouth. The soft tissue intraoral report 64 includes anatomic intraoral soft tissue fields 65 that allows the practitioner to select the particular areas of the mouth for which soft tissue intraoral data is available for input. The software program includes definitions for each anatomic structure; however, the user can add, delete or edit the definitions through the programs definition manager.

The next sub-module of the visual report module is the Soft Tissue-Extraoral examination report sub-module 66, as shown in FIG. 3, is designed to allow the practitioner to report on the conditions outside of the mouth. The soft tissue extraoral report 66 includes anatomic soft tissue extraoral fields 67 that allows the practitioner to select the particular areas outside of the mouth for which soft tissue extraoral data is available for input. The software program includes definitions for each anatomic structure; however, the user can add, delete or edit the definitions through the programs definition manager.)

The next sub-module of the visual report module is the salivary gland report sub-module 68, as shown in FIG. 3. The salivary gland report sub-module 68 is designed to allow the practitioner to report on the conditions of the salivary glands of the mouth. The salivary gland report 68 includes anatomic salivary gland fields 69 that allows the practitioner to select the particular areas of the mouth for which salivary data is available for input. The software program includes definitions for each anatomic structure; however, the user can add, delete or edit the definitions through the programs definition manager.

The sub-modules of the visual report module are compiled into the visual examination report which results in a compilation of the following seven reports: Teeth report, Edentulous report, Occlusion report, TMJ report, Intraoral Soft tissue report, Extraoral Soft Tissue report, Salivary Gland report. The visual examination report 56 is accessible from the date tree 50 for the patient as an individual report or can be compiled into a progress note at the option of the practitioner.

The periodontal charting and examination module 58, as shown in FIG. 3, provides input fields to allow the practitioner to record pocket depth summary, gingival recession summary, tooth mobility and furcation grade. The periodontal charting module 58 includes an anatomic periodontal grid 59 that allows the practitioner to select the particular teeth for which periodontal inspection data is available for input. There are also textual fields within the periodontal examination module that have definitions associated with them. The software program includes definitions for each field with respect to diagnosis, prognosis, and other periodontal findings; however, the user can add, delete or edit the definitions through the programs periodontal exam setup definition manager. The periodontal charting and examination module 56 creates the report and places it in the periodontal charting and examination database and displays the report on the date tree 50 for the patient as an individual report or can be compiled into a SOAP note at the option of the practitioner.

The pulp testing module provides input fields to allow the practitioner to record diagnostic information to establish the health of a tooth with respect to the endodontic space (nerve space-root canal space). The pulp testing module consists of an anatomic grid where the user inputs data with respect to stimuli of heat, cold, ice, percussion, mobility, palpation and electric pulp testing. The data is entered along with the appropriate tooth and stored in the pulp testing database and shown on the date tree. The pulp testing data can be compiled and a written text report is generated and indexed on the date tree as an individual report or can be compiled into a SOAP note at the option of the practitioner.

The diagnosis report module 70, as shown in FIG. 2, provides input fields to allow the practitioner to create a report based upon their diagnosis of the patients observed conditions and test results. The diagnosis report module 70 includes an anatomic grid 71 that allows the practitioner to select the particular area, tooth or anatomic structure for which a diagnosis is being created. The diagnosis report module 70 uses multi-tiered templates to assist the practitioner in adding general and specific diagnosis report data. The diagnosis report module 70 is indexed on the date tree 50 for the patient as an individual report or can be compiled into a progress note at the option of the practitioner.

The treatment plan report module 72, as shown in FIG. 2, provides input fields to allow the practitioner to create a specific treatment plan based upon the diagnostic and relevant test result data. The treatment plan report module 72 includes an anatomic grid 73 that allows the practitioner to select the particular area, tooth or anatomic structure for which a treatment plan is being generated. The treatment plan report module 70 uses multi-tiered templates to assist the practitioner in adding general and specific treatment plan data. The treatment plan report module 72, is placed in the treatment plan database and shown on the date tree 50. The treatment plan report module 72 also includes of a quick entry treatment grid that consists of teeth treatment indication surface or anatomic structure along with indication to allow treatment information to be compiled into readable data and inserted into the treatment plan.

The lab prescription module 74, as shown in FIG. 1, provides input fields to allow the practitioner to create a lab prescription based upon the procedures performed. The lab prescription module 74, creates lab prescriptions and is stored in the lab prescription database and is viewable from the date tree 50. When the prescription data entry is completed or can be compiled into a SOAP note as a lab prescription at the option of the practitioner or compiled into a separated lab prescription to be sent to a laboratory for fabrication of prosthetics.

The drug prescription module 75, as shown in FIG. 1, provides input fields to allow the practitioner to create a drug prescription. There are templated fields with relevant prescription data. Data for the drug prescription module 74, is stored I in a drug prescription database and is accessible from the patient's date tree 50. The prescription data can be compiled into a SOAP note as a drug prescription at the option of the practitioner.

The program 10 is comprised of additional modules that all utilize the multi-tiered templated structure to assist the practitioner to quickly and easily input patient, test or procedure data into the program. The templates are a two-tiered format that are designed to describe generally and in detail information about a certain test or procedure (such as a surgical procedure). The multi-tiered template contains two textual fields: an upper—“main line”—field and a lower—“variable” field. The upper field is a primary template that includes various generalized subject lines that the user or practitioner either “adds” to or “skips” from by clicking or not clicking with the mouse cursor. By clicking on one or more general subject lines in the primary template, the program opens a lower field or secondary template. The lower field is a secondary template that includes specific subject lines that the user or practitioner either “adds” to or “skips” from by selecting or not selecting with the mouse cursor. When the user, in the primary template, advances to the next line of the procedure template field (upper field) the line selected relating to the general subject is highlighted. If variables are present for the line selected in the primary template, the program 10 is prompted to open a secondary template that displays the variables or specific subject lines. The user or practitioner, in the secondary template selects one or more of the variables or specific subject lines that apply by clicking on one or more of the specific subject lines with the mouse cursor. Once all of the general and specific subject matter has been selected, the user or practitioner clicks an add button within the program. The program then compiles both the generalized selected subject matter of the primary template and the related linked variable(s) of the secondary template are merged into the text report screen. The compiled data from both templates is stored in the database for the respective modules. The variables of the primary and secondary templates allow for total flexibility and specificity to accurately “write” to record patient, procedure and test data. While a two tier-template is illustrated containing a primary and secondary tier, additional tiers may be used to allow the practitioner to enter even more specific data. An example of the multi-tiered template is shown below for use with anesthetic. A typical statement in a report created by multi-tiered template data input would be as follows:

“Profound anesthesia was obtained using: One carpule—2% lidocaine hydrochloride (36 mg) with 1:100,000 epinephrine (0.018 mg)”

This report statement was created by first selecting a general subject within the primary template as shown below.

The line: Anesthesia: Profound anesthesia was obtained using:

Once the general subject is selected in the primary template, a secondary template opens to allow the user to select specific subjects or variables as shown below.

| | |
|---|---|
| The variables: | One carpule—2% lidocaine hydrochloride (36 mg) |
| | with 1:100,000 epinephrine (0.018 mg) |
| | Two carpules—2% lidocaine hydrochloride (72 mg) |
| | with 1:100,000 epinephrine (0.36 mg) |
| | Three carpules—2% lidocaine hydrochloride (108 mg) |
| | with 1:100,00 epinephrine (0.054 mg) |
| | Four carpules—2% lidocaine hydrochloride (144 mg) |
| | with 1:100,00 epinephrine (0.072 mg) |
| | Five carpules—2% lidocaine hydrochloride (180 mg) |
| | with 1:100,000 epinephrine (.090 mg) |
| | Six carpules—2% lidocaine hydrochloride (216 mg) |
| | with 1:100,000 epinephrine (0.108 mg) |

The user or practitioner can then select one or more variables from the secondary template. Unique coding allows variables be written for each procedure template line. The user can format an unlimited amount of variables for any given line as needed for the given profession. The typical format of the templates in some of the modules for use in the dental field are as follows: Pre-operative information (reason for visit, informed consent), Chief complaint, Anesthesia, the Procedure performed, Postoperative information, Medications. The software program 10 is equipped with various templates that the user can add, delete or edit to tailor a specific application. There are anatomic grids and custom grids that allow for quick entry of additional information into reports that the user can select from. The anatomic grids cannot be edited. The custom grids can be created, added to, edited, or deleted. Other modules contained in the program are set forth below.

The recall exam module consists of procedure templates that describe in detail a procedure performed (with respect to the recall exam—which is inclusive of, but not limited to oral examination, prophylaxis, intraoral, x-rays, fluoride treatments, etc.

The initial exam module consists of procedure templates that describe in detail a procedure performed (with respect to the initial patient exam—which is inclusive of, but not limited to oral examination, prophylaxis, intraoral, x-rays, fluoride treatments, etc.

The emergency exam module consists of procedure templates that describe in detail a procedure performed (with respect to an emergency exam—which is inclusive of, but not limited to oral examination, intraoral, x-rays, limited or emergent treatment etc).

The phone call module consists of templates that describe in detail a phone call contact made either—to the patient from the office and staff—or—from the patient to the office. The phone call module indicates the source of the phone call (office or patient), stamps the date and the time of the call, who took, the call and the reason for the call. Information is selected and entered in a text field. The text field also allows for the user to select and enter statements from a template field.

The failed appointment module consists of a one statement text report: “patient failed to show up for appointment”. This report cannot be edited. The failed appointment report is compiled into its own text report and is indexed on the date tree 50 for the patient as an individual report or can be compiled into a progress note at the option of the practitioner.

To create a SOAP note within the program, each report for a particular date is electronically obtained from the database in which it is stored and places the information into a “container” (a container is a temporary holder for a report). Then, using the SOAP order (subjective, objective, assessment, treatment plan) the program organizes and labels the containers. At that point in time a main container is created in which all the other containers fit in accordance to their labels. The main container is then displayed on the main screen and labeled as a SOAP Note.

When the user creates a report, the program displays a date grid for the user to select the date he/she wants to create a report for. The program checks the “Allocation Table” for a report with the same chart number, date, and type. If the program find an existing report, an error message will be displayed and alert the user that a report already exists and to select another date. If a report is not found then the program displays the appropriate report screen. The user then enters data into the report as desired. When a report is completed, a new record is added by the program to the appropriate database and also adds a separate parallel entry in the “Allocation Table”

On the main interface 14 there is a function that allows the medical and dental software program to be linked with other software. The administrative software and the medical and dental software program must have the same chart number. When the user clicks on the function, a series of additional functions are displayed that the user can select from to gain access to the administrative software without exiting the medical and dental software program.

An abridged version of medical and dental software program allows the user to download certain databases onto a disk, load the databases onto a remote computer, create procedure notes on the disk, remove the disk, return the disk to the computer where the unabridged medical and dental software is used and upload the new reports into existing patient charts without overriding existing data in the patients' charts. The medical and dental software program also includes digital radiograph image storage, voice recognition for the various modules to allow for hands free data entry. The medical and dental software program also includes document centers, medical history for individual patients and consent forms that utilize a signature pad so that the patient can electronically sign their names to HIPPA forms, Consent forms, Medical history forms, insurance assignment forms, Treatment plan acceptance forms, and any other forms that require patient signature.

Various features of the invention have been particularly shown and described in connection with the illustrated embodiment of the invention, however, it must be understood that these particular arrangements merely illustrate, and that the invention is to be given its fullest interpretation within the terms of the appended claims.

What is claimed is:

1. A computer implemented method of recording medical and dental information and compiling and writing a progress note comprising the steps of:
entering general and specific patient symptom data into a subjective module wherein the subjective module includes preformatted primary and secondary templates adapted to permit the user to electronically enter the general and specific patient symptom data into the report;
assigning a patient identifier to the patient symptom data and storing the symptom data in a database;
entering diagnostic data, from patient test results and physical examination, into specific information gathering modules, the specific information gathering modules including anatomic fields adapted to permit the user to select an anatomic region and enter diagnostic data into the anatomic fields, the recorded diagnostic data given the specific patient identifier and stored in a database by the patient identifier;
compiling a progress note based upon the recorded patient symptoms and diagnostic data.

2. The computer implemented method of recording medical and dental information and compiling and writing a progress note of claim 1, further including the step of displaying the recorded diagnostic data on a date tree.

3. The computer implemented method of recording medical and dental information and compiling and writing a progress note of claim 1, wherein the recorded medical and dental information is password protected.

4. A computer implemented method of creating an electronic progress note for a patient in an information gathering system comprising the following steps:
assigning an identifier to the patient;
inputting general and specific examination and test data into multi-tiered linked templates associated with system modules, the general and specific examination and test data entered into one or more of the multi-tiered linked templates and merged to form underlying report data;
storing the inputted report data into categorized databases, the inputted report data marked with the patient identifier to permit the patient's report data to be recalled from the databases;
compiling the report data stored in the databases to create a patient report;
assigning the patient identifier to the patient report;
archiving the patient report, the archived patient report assigned the patient identifier.

5. A computer-implemented method for diagnosing a medical and dental condition, the method comprising the steps of:
providing an interface for entering patient symptom, diagnostic and test data, the interface including multi-tiered preformatted template containing an anatomic grid;
entering patient test data into the anatomic grid by selecting one or more anatomic regions, the selecting of the one or more anatomic regions prompting the opening of at least one template;
selecting one or more subject lines of the at least one template;
merging the anatomic grid selections with corresponding selected subject lines and storing in a database;
compiling a progress note based off of the selected anatomic and subject line data.

6. A computerized system for creating and managing medical and dental treatments, the system comprising a storage device, memory, a program module, a communications interface, and a processor responsive to a plurality of instructions from the program module, being operative to:
provide an interface for entering patient test data, the interface including primary and secondary templates, the secondary templates being linked to the primary templates;
selecting subject lines from the primary template related to an anatomic region in which patient test data is to be applied, selecting subject lines of the primary template prompting the opening of at least one secondary template;
selecting subject lines from the secondary template related to specific test data findings;
merging selected information from the primary and secondary templates and storing the selected information in a database;
compiling the selected data into a progress note.

7. A computer-readable medium or modulated signal being encoded with computer-executable instructions to manage client dental and medical information, comprising:
a consultation software module, the consultation software module containing code for collecting notes made during a consultation with a client and formatting the notes into SOAP format;
a diagnostic module, the diagnostic module containing code for generating a diagnosis based on subjective and objective factors collected by the consultation software module; and
a treatment software module, the treatment software module containing code for generating a treatment plan, the treatment plan including a series of treatment units, the treatment software further containing code to record progress information related to the series of treatment units.

8. A computer implemented method of recording information and creating a data compilation comprising the steps of:
selecting a general subject line within a primary template, selecting the general subject line prompting the opening of a secondary template containing specific subject lines that are linked to the specificity of the general subject line of the first template;
selecting at least one of the specific subject lines of the secondary template;
compiling the general subject line of the primary template with the at least one specific subject lines of the secondary template to create at least one data compilation.

9. The computer implemented method of recording information and creating a data compilation of claim 8 wherein the primary template includes an anatomic grid that permits a user to select at least one anatomic region in which data is to be entered; selecting the anatomic region prompting the opening of the secondary template containing the specific subject lines, selectable by the user.

10. The computer implemented method of recording information and creating a data compilation of claim 8 further comprising the step of creating a patient chart wherein the patient chart is assigned an individualized patient code.

11. The computer implemented method of recording information and creating a data compilation of claim 10 further comprising the step of accessing one or more modules when within the patient chart to record patient related data.

12. The computer implemented method of recording information and creating a data compilation of claim 11 further comprising the step of storing the patient related data in one or more databases, the patient related data identified by the individualized patient code.

13. The computer implemented method of recording information and creating a data compilation of claim 11 wherein the data compilation from the primary and secondary templates is arranged in a textual progress note.

14. The computer implemented method of recording information and creating a data compilation of claim 11 wherein the modules include the primary and secondary templates to record patient data, the modules designed to receive input relating to patient symptoms, diagnostic test data, practitioner diagnosis and patient treatment.

15. The computer implemented method of recording information and creating a data compilation of claim 14 wherein the diagnostic test data includes visual, physical, radiographic data.
